(19) United States
(12) Patent Application Publication
(10) Pub. No.: US 2007/0029770 A1
(43) Pub. Date: Feb. 8, 2007

(54) Grill accessories

(76) Inventor: Taylor Christopher Carthern, Atlanta, GA (US)

Correspondence Address: Taylor Carthern, 110 Old Fairburn Close, Atlanta, GA, 30331, US

(21) Appl. No.: 11/187,308

(22) Filed: Jul. 22, 2005

(51) Int. Cl. B60J 11/00

(52) U.S. Cl. 280/770

(57) ABSTRACT

This present invention relates to having a grill for your vehicle on your mirror and/or on your door handle, and/or on your grill gas caps, and/or on your rims will be rim inserts and all of these accessories will match the grill on the front of your car. Some door handles will be painted and in color and some will be chrome. Some rims will be in color. We will also have backlight covered grills for your lights that will match the front of the grill. A design for a grill kit for a vehicle including, a side, front and back kit that will have spaces in it that will have grill inserts to match the grill on the front of the car, this is also with or without exhaust pipe with grill, window cover with grill, backlight with grill, grilled gas covers, grill door handle and the design from claim 1 that all match the grill on the front of the vehicle. Grills will be made of all types of material including but not limited to, iron, aluminum, all steel (including stainless), mesh, etc.

### BACKROUND—FIELD OF INVENTION

This present invention relates to having a grill for the outside of your mirror of your car or truck, or any other vehicle that matches the same grill that is on the front of your vehicle. You will also be able to change the existing grill on your car and get that matching grill for your mirror. No one has ever made a mirror grill on the car that matches the grill on the front of the car or the grill insert on rims to match the grill, the grill insert on the door handles to match the grill on the front, and grilled gas covers to match the front of the grill. There is a need that we will fill with our design by providing owners of new and used vehicles with grills for there mirrors that will be made, rims with grill inserts(mesh) to match the grill on the front of the car, and grill inserts for door handles to enhance the appearance of your car. For Example you have BMW with a nice grill on the front of it. We will have some rims (in color or chrome) with grill inserts to match the front grill, and/or grill inserts for the door handles (in color and chrome), and/or grills on the mirrors, backlight grill to match the grills.

### BACKGROUND OF INVENTION

This invention relates to the design of chrome grills on the front of vehicles and we will add mirror grills, the grill insert on rims, the grill insert on the door handles, grilled gas covers.

1. Description of Related Inventions

For some car models they have on the front of the automobile they have grills, some which are chrome, that look great. But they are missing the matching design of the grill but on the mirrors, the grill insert on rims, the grill insert on the door handles, grilled gas covers.

2. Objects and Advantages

Several of the advantages of my invention include:
1. Our design will enhance the design and style of all automobiles.
2. It will enhance the value of your automobile.

### SUMMARY OF INVENTION

This present invention relates to having a grill for your vehicle on your mirror and/or on your door handle, and/or on your grill gas caps, and/or on your rims will be rim inserts and all of these accessories will match the grill on the front of your car. Some door handles will be painted and in color and some will be chrome. Some rims will be in color. We will also have backlight covered grills for your lights that will match the front of the grill. Grills will be made of all types of material including but not limited to, iron, aluminum, all steel (including stainless), mesh, etc.

### BRIEF DESCRIPTION OF DRAWINGS

FIG. 1 displays the door handle of the car in which the door handle matches the grill on the front of the car. FIG. 1-100 displays the inside of the handle which can be made of any material, it could be grilled or chrome. FIG. 1-200 displays the actual handle on the door, which can be any material including chrome and can be the color of the car. FIG. 1-300 displays the grill material that matches the grill on the front of the car, in which this is just an example and not all our designs.

FIG. 2 displays the rim set to match a grill. FIG. 2-100 shows how the rim can be in the color of the car or not, and can be made of chrome and other material. FIG. 2-200 shows the rim part that matches the grill and is made of the same material that the grill is made of.

FIG. 3 displays the steering wheel set to match a grill. FIG. 3-100 shows how the steering wheel can be made of chrome and other material. It also shows the steering wheel part that matches the grill and is made of the same material that the grill is made of.

FIG. 4 displays the gas pump and how it will match the grill on the front of the car. FIG. 4-100 shows the part that outside of the pump that will be made of any material, shown in chrome. FIG. 4-200 shows the Cadillac Specs Grill that matches the front of the car and opens to pump your gas.

FIG. 5 displays the gas caps and how it will match the grill on the front of the car. FIG. 5-200 shows the part that outside of the pump that will be made of any material, shown in chrome. FIG. 5-100 shows the Cadillac Grill filler that matches the front of the car and opens to pump your gas.

FIG. 6 shows the backlight cover in which it will match the grill. The light will be covered and FIG. 6-100 shows how the light is covered with the grill material on the outside to match the grill. FIG. 6-200 shows the inside that will be your light.

FIG. 7 shows the Chrysler grill. FIG. 7-100 is the grill. FIG. 8 is a picture of the matching rims that will match the grill. FIG. 8-100 is the grill material and FIG. 8-200 will be made of chrome, can be grill material or any other material.

FIG. 9 displays the mirror cover to match the front of the grill. FIG. 9-100 shows the grill window guard that is shown made of the grill material to match the grill. FIG. 9- 200 is the mirror and FIG. 9-300 is the car window.

FIG. 10 displays muffler made with grill material, not just shown in various styles. FIG. 10-100 shows the grill material to match the front of the car and FIG. 10-200 is the muffler made of many material including chrome.

FIG. 11 is the board used to step up into your vehicle. FIG. 11-100 and FIG. 11-200 shows the step up board matching the grill on the car.

FIG. 12 shows the step up board on a Yukon Denali. FIG. 12-100 is the actual step up board and FIG. 12-200 is the actual grill matching the grill on the Denali.

FIG. 13 shows the grill on a Dodge Ram. This is used to show that the step up board in FIG. 11 matches the grill for the Dodge Ram.

FIG. 14 displays front of a grill on a vehicle with a fender grill to match the grill enhancing the appearance of the vehicle. FIG. 13-100 is the actual fender grill made of the grill material. FIG. 13-200 shows the actual grill on the vehicle that is matched by the fender grill.

FIG. 15 shows the rims that match a grill for a Cadillac. FIG. 15-100 shows the inside of a rim that can be made of the rim material or any other material, or can be empty. FIG. 15-200 shows the actual Grill filler in the rim that matches the front grill on the car.

FIG. 16 shows the front grill that is matched by the rims in FIG. 15.

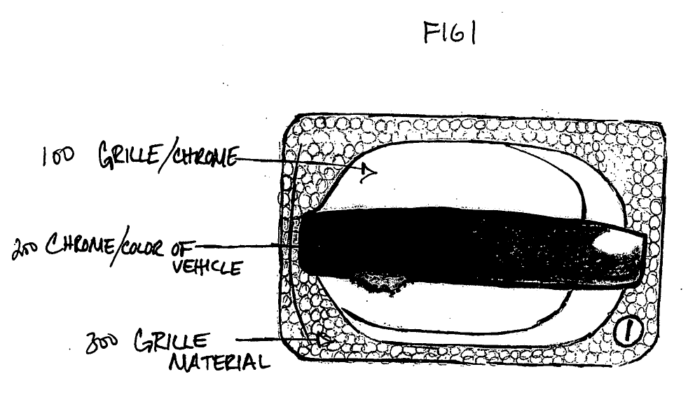

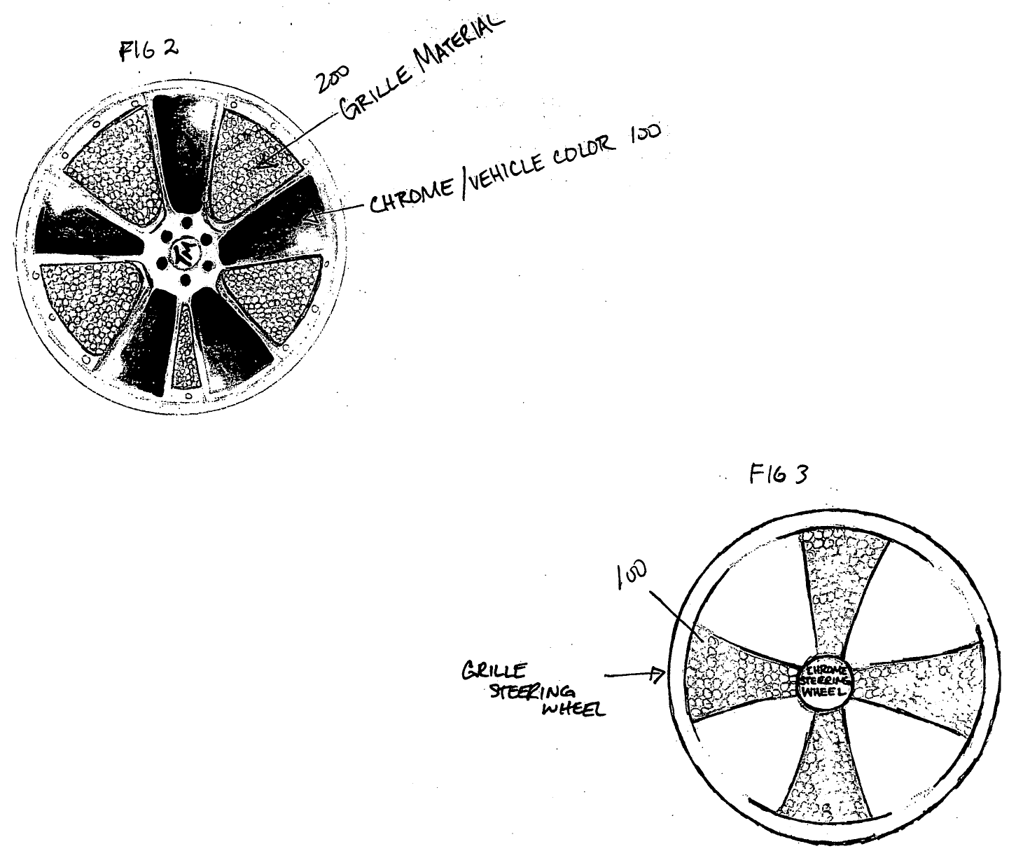

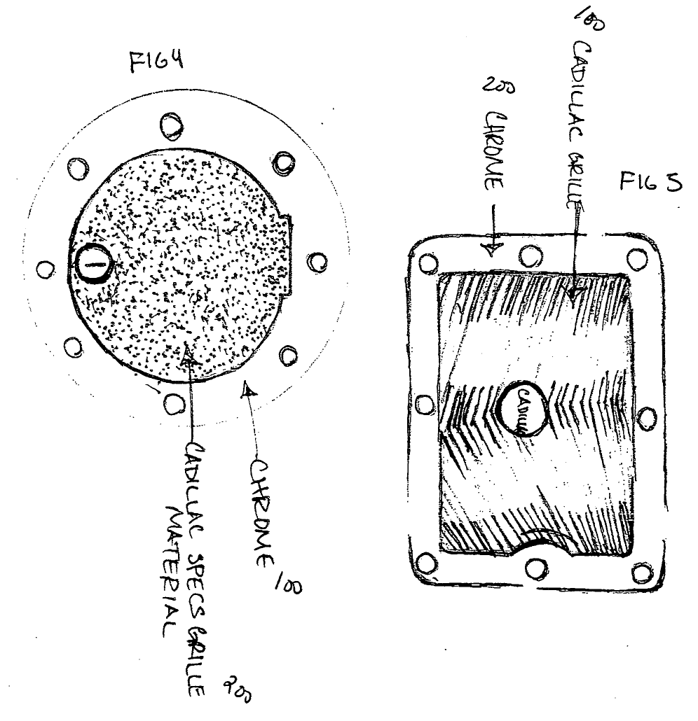

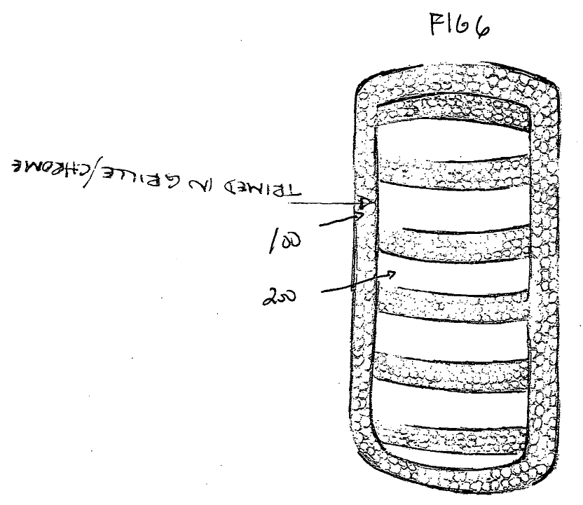

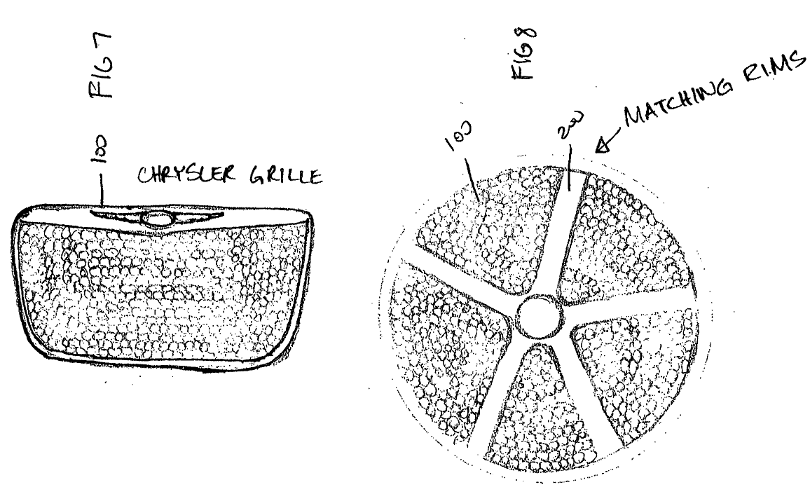

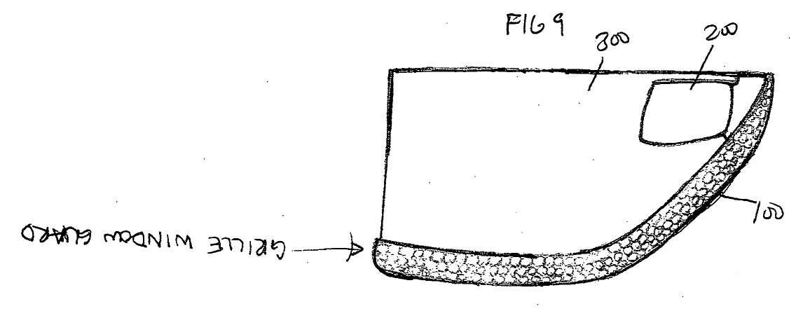

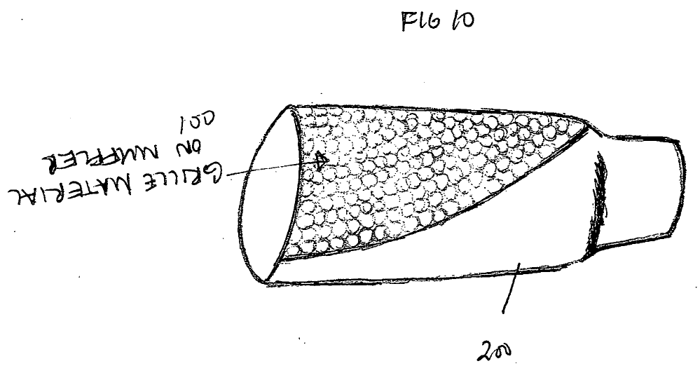

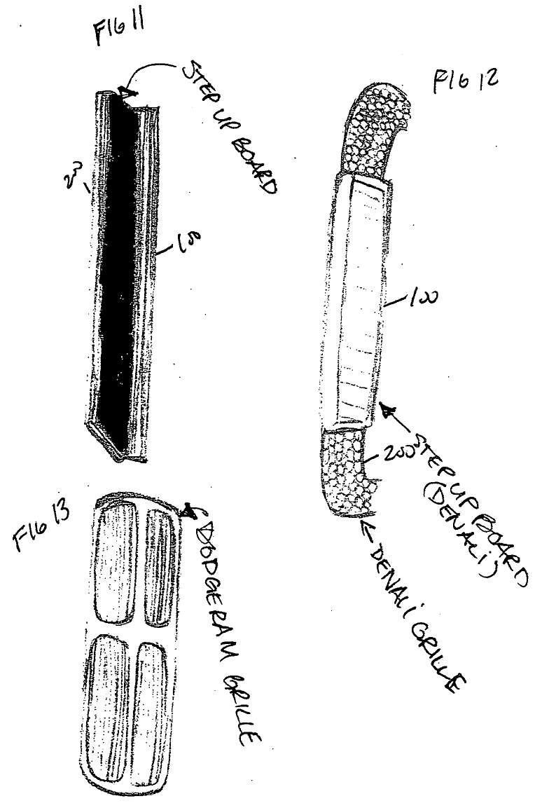

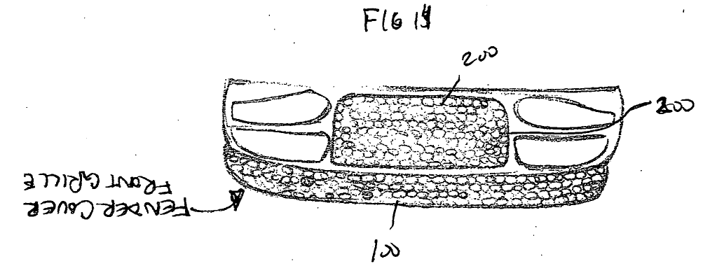

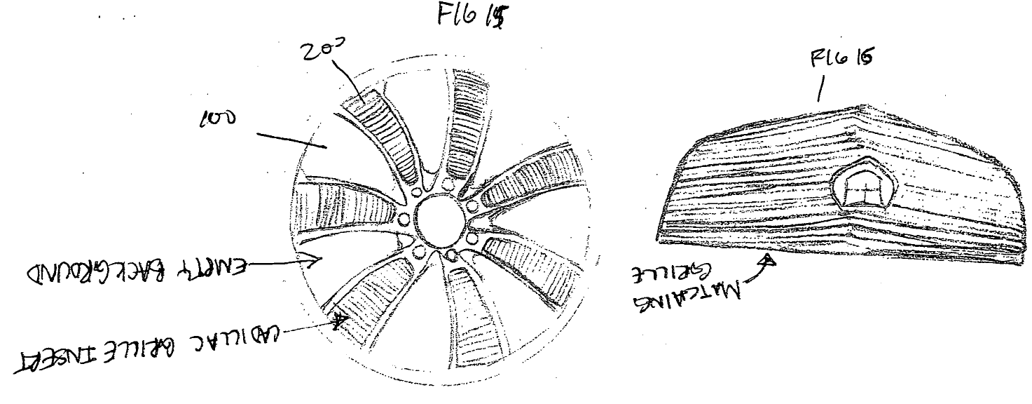

### DETAILED DESCRIPTIONS OF DRAWINGS

This present invention relates to having a grill for your vehicle on your mirror and/or on your door handle, and/or on your grill gas caps, and/or on your rims will be rim inserts and all of these accessories will match the grill on the front of your car. Some door handles will be painted and in color and some will be chrome. Some rims will be in color. We will also have backlight covered grills for your lights that will match the front of the grill. Also we will have grilled matching window covers for vehicles to match the grill on the front of the car. We will also feature grilled gas covers to cover the gas tank that will match the grill on the front of the car. We have a design for a grill kit for a vehicle including, a side, front and back kit that will have spaces in it that will have grill inserts to match the grill on the front of the car, this is also with or without exhaust pipe with grill, window cover with grill, backlight with grill, grilled gas covers, grill door handle and the design from claim 1 that all match the grill on the front of the vehicle.

What I claim as my invention is:

1. A design for all vehicles that has grill inserts on the rim to match already existing front grills manufactured by car makers, or custom (including but not limited to Cadillacs, GMC, Jaguar, Chrysler, Lincoln, Chevrolet, BMW, Mercedez, Range Rover, Pontiac, Ford, Dodge, Infiniti, VW, Bentley, Rolls Royce, Lexus, Honda, Toyota, Volvo, includes all cars, trucks, SUV's and vans) including rim may or may not be in color or chrome, with or without grill caps, spinners that are the grill inserts that spin around the chrome of color rim. Also they will or will not match the grill on the mirrors. Grills will be made of all types of material including but not limited to, iron, aluminum, plastic, all steel (including stainless), chrome, mesh, etc.

2. A design for all vehicles that has grill inserts on the door handle and also outline the handle including the handle can be grilled, painted or not painted, chrome or not chrome, where the inserts match the grill on the front of the car and may or may not have grill mirrors to match both the handles and the grill on the front of the vehicle.

3. A design for all vehicles that has grilled gas caps to cover the gas tank that will match the front grill on the vehicle, they will be made of chrome or painted, will match if it has any on the car the grill mirrors also.

4. A design for all vehicles that has a grill for the backlight covers that cover the lights of the vehicle to match the grill on the front of the vehicle. The grill may outline of the light cover or be in a design and will also match the mirror grills on the car.

5. A design for all vehicles that has grilled window covers on top of the windows of the car used to shield water. They will be painted or made of chrome and matching the front of the grill on the vehicle and also the mirror grills. Grills will be made of all types of material including but not limited to, iron, chrome, aluminum, plastic, all steel (including stainless), mesh, etc.

6. A design for all vehicles that has side, back window grill inserts for trucks that will match the grill on the front of the vehicle and if any the mirror grills on the car. Grills will be made of all types of material including but not limited to, iron, aluminum, plastic, all steel (including stainless), chrome, mesh, etc.

7. A design for all vehicles that has exhaust pipe with the tip or the entire exhaust pipe that has a grill to match the front of the car with or without the matching mirror grills. Grills will be made of all types of material including but not limited to, iron, aluminum, all steel (including stainless), plastic, chrome, mesh, etc.

8. The design from claim 1 with or without the design from claim 2 with or without the designs from claims and with or without the designs from claims 3, 4, 5, 6, and/or 7.

9. The design from claim 1 including a design for all vehicles that has grill inserts on the door handle and also outline the handle including the handle can be grilled, painted or not painted, chrome or not chrome, where the inserts and rims match the grill on the front of the car and may or may not have grill mirrors to match both the handles and the grill on the front of the vehicle. Grills will be made of all types of material including but not limited to, iron, aluminum, plastic, chrome, all steel (including stainless), mesh, etc.

10. The design from claim 1 including a design for all vehicles that has grill inserts on the door handle and also outline the handle including the handle can be grilled, painted or not painted, chrome or not chrome, where the inserts and rims match the grill on the front of the car and may or may not have grill mirrors to match both the handles and the grill on the front of the vehicle and including a design for a vehicle that has grilled gas caps to cover the gas tank that will match the front grill on the vehicle, they will be made of chrome or painted, will match if it has any on the car the grill mirrors also. Grills will be made of all types of material including but not limited to, iron, aluminum, all steel (including stainless), plastic, chrome, mesh, etc.

11. The design from claim 1 including a design for all vehicles that has grill inserts on the door handle and also outline the handle including the handle can be grilled, painted or not painted, chrome or not chrome, where the inserts and rims match the grill on the front of the car and may or may not have grill mirrors to match both the handles and the grill on the front of the vehicle and including a design for a vehicle that has grilled gas caps to cover the gas tank that will match the front grill on the vehicle, they will be made of chrome or painted, will match if it has any on the car the grill mirrors also, including A design for a vehicle that has a grill for the light covers that cover the lights of the vehicle to match the grill on the front of the vehicle. The grill may outline of the light cover or be in a design and will also match the mirror grills on the car. Grills will be made of all types of material including but not limited to, iron, aluminum, all steel (including stainless), chrome, plastic, mesh, etc.

12. The design from claim 1 including a design for all vehicles that has grill inserts on the door handle and also outline the handle including the handle can be grilled, painted or not painted, chrome or not chrome, where the inserts and rims match the grill on the front of the car and may or may not have grill mirrors to match both the handles and the grill on the front of the vehicle and including a design for a vehicle that has grilled gas caps to cover the gas tank that will match the front grill on the vehicle, they will be made of chrome or painted, will match if it has any on the car the grill mirrors also, including A design for a vehicle that has a grill for the light covers that cover the lights of the vehicle to match the grill on the front of the vehicle. The grill may outline of the light cover or be in a design and will also match the mirror grills on the car, including A design for a vehicle that has grilled window covers on top of the windows of the car used to shield water. They will be painted or made of chrome and matching the front of the grill on the vehicle and also the mirror grills. Grills will be made of all types of material including but not limited to, plastic, iron, aluminum, all steel (including stainless), chrome, mesh, etc.

13. The design from claim 1 including a design for all vehicles that has grill inserts on the door handle and also outline the handle including the handle can be grilled, painted or not painted, chrome or not chrome, where the inserts and rims match the grill on the front of the car and may or may not have grill mirrors to match both the handles and the grill on the front of the vehicle and including a design for a vehicle that has grilled gas caps to cover the gas tank that will match the front grill on the vehicle, they will be made of chrome or painted, will match if it has any on the car the grill mirrors also, including A design for a vehicle that has a grill for the light covers that cover the lights of the vehicle to match the grill on the front of the vehicle. The grill may outline of the light cover or be in a design and will also match the mirror grills on the car, including A design for a vehicle that has grilled window covers on top of the windows of the car used to shield water. They will be painted or made of chrome and matching the front of the grill on the vehicle and also the mirror grills including A design for a vehicle that has side, back window grill inserts for trucks that will match the grill on the front of the vehicle and if any the mirror grills on the car. Grills will be made of all types of material including but not limited to, plastic, iron, aluminum, all steel (including stainless), chrome, mesh, etc.

14. The design from claim 1 including a design for all vehicles that has grill inserts on the door handle and also outline the handle including the handle can be grilled, painted or not painted, chrome or not chrome, where the inserts and rims match the grill on the front of the car and may or may not have grill mirrors to match both the handles and the grill on the front of the vehicle and including a design for a vehicle that has grilled gas caps to cover the gas tank that will match the front grill on the vehicle, they will be made of chrome or painted, will match if it has any on the car the grill mirrors also, including A design for a vehicle that has a grill for the light covers that cover the lights of the vehicle to match the grill on the front of the vehicle. The grill may outline of the light cover or be in a design and will also match the mirror grills on the car, including A design for all vehicles that has grilled window covers on top of the windows of the car used to shield water. They will be painted or made of chrome and matching the front of the grill on the vehicle and also the mirror grills including A design for a vehicle that has side, back window grill inserts for trucks that will match the grill on the front of the vehicle and if any the mirror grills on the car. Grills will be made of all types of material including but not limited to, iron, plastic, aluminum, all steel (including stainless), chrome, mesh, etc.

15. A design for all vehicles that has grill inserts on the steering wheel and the inside of the steering wheel can be grilled, painted or not painted, chrome or not chrome, where the inserts match the grill on the front of the car and may or may not have grill mirrors to match both the handles and the grill on the front of the vehicle. Grills will be made of all types of material including but not limited to, plastic, iron, aluminum, all steel (including stainless), chrome, mesh, etc.

16. The design from claim 3 with or without the designs from claims 1, 2, 4, 5, 6 and/or 7.

17. The design from claim 4 with or without the designs from claims 1, 2, 3, 5, 6 and/or 7.

18. The design from claim 5 with or without the designs from claims 1, 2, 3, 4, 6 and/or 7.

19. The design from claim 6 with or without the designs from claims 1, 2, 3, 4, 5, and/or 7.

20. The design for a grill kit for all vehicles including, a side, front and back kit that will have spaces in it that will have grill inserts to match the grill on the front of the car, this is also with or without exhaust pipe with grill, window cover with grill, backlight with grill, grilled gas covers, grill door handle and the design from claim 1 that all match the grill on the front of the vehicle. Grills will be made of all types of material including but not limited to, iron, chrome, aluminum, all steel (including stainless), plastic, mesh, etc.
